(19) United States
(12) Patent Application Publication
(10) Pub. No.: US 2026/0338297 A1
(43) Pub. Date: Oct. 29, 2026

(54) TUBE STRUCTURE FOR RESILIENCE AGAINST FREEZE-THAW FRACTURE

(71) Applicant: Blue Origin Manufacturing, LLC, Huntsville, AL (US)

(72) Inventor: John Paul Brendel, Coeur D’Alene, ID (US)

(21) Appl. No.: 19/191,815

(22) Filed: Apr. 28, 2025

(51) Int. Cl. F16L 3/137; F16L 11/14; F16L 53/70

(52) U.S. Cl. CPC F16L 3/137; F16L 11/14; F16L 53/70

(57) ABSTRACT

A tube that is configured to be resilient against bursting when its contents change phase is introduced. For example, water freezing to ice in a tube will volumetrically expand so as to impart outward pressure on the wall of the tube. This outward pressure can be large enough to burst the tube. Tubes, or tubing, that can resist such bursting are described as having an oval cross-section that can expand in one direction while contracting in another direction during a phase change event. The changing shape of the oval cross-section leads to a volumetric increase of the tube, which can thus accommodate an increased volume of a phase-changed material.

### BACKGROUND

Tubes or tubing used to transport various fluids, such as water, oil, and cooling fluids, just to name a few examples, are generally vulnerable to certain environmental conditions. A common issue is the potential for bursting due to freeze-thaw cycles. Common liquids, such as water, expand when they freeze, exerting pressure on walls of the tube. If this pressure surpasses the tube's capacity to circumferentially expand, it can lead to the tube bursting. This is a frequent problem in colder climates where water pipes can freeze and burst. Also, in space, temperatures can vary dramatically from extremely hot to extremely cold, depending on whether an object is in direct sunlight or in the shadow of another object, for example. These extreme temperatures can have a significant impact on the state of the liquid in a tube.

In view of these issues, in addition to managing temperatures to which they are exposed, the tubes themselves may be configured or designed to withstand various environmental factors. Some design solutions, however, may have shortcomings, such as added mass and cost. Thus, there are continuing efforts to find favorable solutions to the general problem of tubes bursting when their contents changes phase.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a cross-section view of an oval resilient tube, according to some embodiments.

FIG. 2 is a cross-section view of an oval resilient tube before and after internally imposed forces are applied, according to some embodiments.

FIG. 3 is a cross-section view of an oval resilient tube having a varying wall thickness, according to some embodiments.

FIG. 4 is a cross-section view of an oval resilient tube mounted onto a radiator by a clip, according to some embodiments.

FIG. 5 is a perspective view of a radiator that includes oval resilient tubes mounted thereon, according to some embodiments.

FIG. 6 is a perspective view of a radiator that includes oval resilient tubes mounted thereon, according to other embodiments.

FIG. 7 is a cross-section close-up view of a thermally conductive resilient material between a retainer clip and a shape-changed tube, according to some embodiments.

FIG. 8 is a cross-section close-up view of a thermally conductive resilient material between a support structure and a shape-changed tube, according to some embodiments.

### DETAILED DESCRIPTION

This disclosure describes, among other things, a tube that is configured to be resilient against bursting when its contents change phase. For example, water freezing to ice in a tube will volumetrically expand so as to impart outward pressure on the wall of the tube. This outward pressure can be large enough to burst the tube. Tubes, or tubing, that can resist such bursting are described herein.

Generally, a tube is a hollow cylindrical structure typically made of metal, plastic, rubber, or other materials, designed to carry liquids, gases, or sometimes solids from one location to another. Herein, however, instead of a cylindrical structure, having a circular cross-section, tubes may have an oval cross-section. Regardless of cross-sectional shape, tubes may be used in a wide range of applications, including plumbing, medical devices, industrial processes, research, and spacecraft, just to name a few examples. Tubing can vary in diameter, length, flexibility, and material, depending on their specific use. Accordingly, claimed subject matter is not limited in these respects.

As described in example embodiments below, a tube having an oval cross-section may change shape during a phase change of material in the tube. In general terms, the shape may change from an oval cross-section toward a circular cross-section as the phase changed material exerts outward pressure on the inside wall of the tube. The changing cross-section provides an increasing tube volume for the phase-changing material in the tube to expand, thus alleviating some of the pressure that could otherwise burst the tube (e.g., fracture the tube wall).

In some particular embodiments, a tube as described above may be part of a resilient tube system that includes retainer clips that fasten the tube to a surface or object. For example, the surface or object may be a thermal radiator and the tube may be configured to carry a heat-transporting fluid. Accordingly, in some implementations, a resilient tube system may comprise a tube that is configured to carry a fluid, wherein the tube i) has an oval cross-section with a top portion, a bottom portion, and side portions, and ii) is widest in a first direction and narrowest in a second direction that is perpendicular to the first direction, such that the top portion and the bottom portion are wider than the side portions. The resilient tube system may also comprise a retainer clip that applies a net downward force in the second direction on at least part of the top portion of the tube. The retainer clip may be configured to change shape to conform with the shape of the tube as the tube expands in the second direction, as described below.

Because of its physical and geometrical nature, the tube may tend to retract in the first direction while expanding in the second direction. The retracting and the expanding may be in response to a changing phase of the fluid inside the tube. For example, some liquids expand when they freeze. Other liquids contract when they freeze. Accordingly, the latter liquids, in the solid frozen phase, may expand when they melt.

The resilient tube system may also comprise a support structure to support the tube and to counter the net force of the retainer clip. In some implementations, a thermally conductive resilient material may be disposed between at least part of the bottom portion of the tube and the support structure. A thermally conductive resilient material may also be disposed between at least part of the top portion of the tube and the retainer clip.

In some particular embodiments, a resilient tube system for carrying a fluid may comprise oval tubing that is configured to deform from an oval cross-section toward a circular cross-section during a phase change of the fluid between a liquid and a solid. The system may also comprise a retainer clip that is configured to apply a net downward force on a top of the oval tubing. A support structure may be configured to support a bottom of the oval tubing and to counter the net downward force of the retainer clip. The retainer clip may be configured to conform with the shape of the oval tubing as the oval tubing deforms from the oval cross-section toward the circular cross-section. In some implementations, a thermally conductive resilient material may be disposed between the top of the oval tubing and the retainer clip and/or between the bottom of the oval tubing and the support structure. In some cases, the oval tubing may be thermally connected to a radiator by the retainer clip and the support structure.

In some embodiments, a thermal radiator system may include a radiator base and oval tubing that is configured to carry a fluid. The oval tubing may be configured to deform from an oval cross-section toward a circular cross-section during a phase change of the fluid between a liquid and a solid. The thermal radiator system may further include a retainer clip that is configured to apply a net downward force on a top of the oval tubing and a support structure mounted to the radiator base and configured to support a bottom of the oval tubing and to counter the net downward force of the retainer clip. The retainer clip may be configured to conform with the oval tubing as the oval tubing deforms from the oval cross-section toward the circular cross-section. At least a portion of the support structure may be sandwiched between distal ends of the retainer clip and the radiator base.

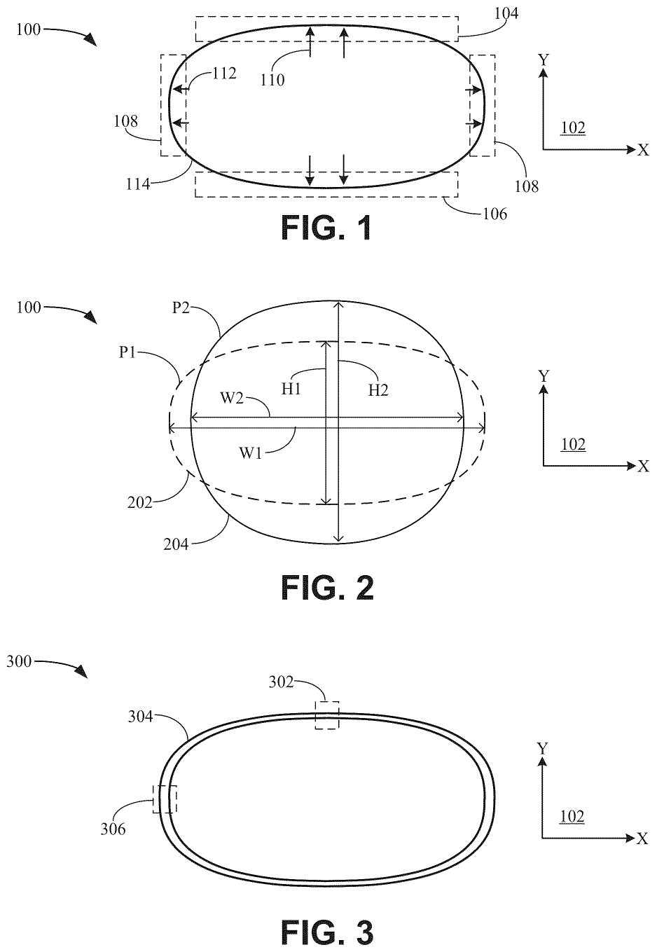

FIG. 1 is a cross-section view of an oval resilient tube 100, according to some embodiments. X-Y axes 102 are included in the figure for directional reference. Tube 100 is widest in the X-direction and narrowest in the Y-direction, which is perpendicular to the X-direction. Accordingly, a top portion 104 and the bottom portion 106 are wider than the side portions 108. Top portion 104, bottom portion 106, and side portions 108 are approximately indicated by dashed rectangles in the figure. Vertical arrows 110 and horizontal arrows 112 indicate forces that may act from inside tube 100 that are exerting an outward pressure on wall 114 of tube 100. These forces may arise from a liquid and/or a solid that is inside the tube, as explained below.

In some implementations of tube 100, material (e.g., fluid and/or solid) inside the tube may be in either of four general conditions: liquid, solid, phase-changing liquid to a solid, or phase-changing solid to a liquid. Each of these conditions may affect the tube wall in particular ways, as now described. Other possible conditions, such as a gas phase of the material, are herein recognized as being possible but not discussed.

When tube 100 is filled with liquid, and no other phase, the liquid may exert outward forces 110, 112 on the tube wall uniformly (e.g., assuming non turbulent flow and ignoring externally applied forces such as gravity) such that these forces are equal for all parts of the wall perimeter. Forces 110, 112 may arise from a pressure applied to the liquid from a pump, for example. In contrast, when tube 100 is filled with a solid, such as ice, the solid may likely exert outward forces 110, 112 on the tube wall nonuniformly such that these forces are not equal for different parts of the wall perimeter. Nonuniform forces may also be present during a phase change from a solid to a liquid and during and after a phase change from a liquid to a solid. For a tube having a circular cross-section (not illustrated), internally applied outward uniform forces may lead to the tube having a larger diameter while still maintaining a circular cross-section. On the other hand, internally applied outward uniform forces applied to the wall of the tube (having a circular cross-section) may lead to its cross-section departing from a circular shape.

Interestingly, in contrast to a tube having a circular cross-section, as discussed above, uniform and nonuniform forces applied to wall 114 of oval tube 100 both affect its cross-section in the same way. In particular, such forces tend to reshape the oval cross-section toward a more circular cross-section (e.g., the height of the oval increases as the width decreases). This is because top and bottom portions 104, 106 have larger surface areas upon which these forces can be applied as compared to the smaller surface areas of side portions 108. As the oval cross-section of tube 100 tends toward a more circular cross-section, the cross-sectional area increases, resulting in a volumetric increase of the tube. This volumetric increase may allow for a phase changing liquid or solid to expand without fracturing wall 114, for example.

In some embodiments, wall 114 of oval resilient tube 100 may be described by the set of parametric equations X=a(cos(t))(1+fcos²(t)) and Y=b(sin(t))(1+fsin²(t)), wherein t is the parametric variable, a and b are constants that determine, in part, a maximum width in the respective X, Y directions, and f is a constant that may determine a “flatness” of the oval shape. For this equation to apply to FIG. 1, for example, the origin of X-Y axes 102 is at the center of wall 114 of tube 100. For a particular numeric example, a=2, b=1, and f=0.2, which results in an oval similar to or the same as that depicted in FIG. 1. In some implementations, f has a value between about 0.05 and 0.2. Generally, as f decreases, the oval may approach the shape of an ellipse. Accordingly, for relatively large values of f (e.g., up to about 0.2), the oval, and thus the cross-section of tube 100, is not an ellipse. However, claimed subject matter (unless so claimed) is not limited to any particular shape or characteristic of a tube's cross-section. Thus, a tube having an elliptical or circular cross-section, or even a rectangular cross-section, may be applied to embodiments herein.

FIG. 2 is a cross-section view of oval resilient tube 100 before and after internally imposed forces are applied, according to some embodiments. Outline 202 is tube 100 before internally imposed forces (e.g., 110 and 112) are applied and outline 204 is tube 100 after internally imposed forces are applied. As explained above, internally applied outward forces tend to reshape the oval cross-section toward a more circular cross-section. Accordingly, the height of the oval increases as the width decreases. For example, an initial height H1 of tube 100 may increase to a final height H2 while an initial width W1 decreases to a final width W2. Meanwhile, during this dimensional change, the initial perimeter P1 remains constant and is thus the same as final perimeter P2. In general, compared to an oval shape, the more circular the cross-section, the greater the area, such that the area within P2 is greater than the area within P1. For example, for a given perimeter, a circle having a greater area than an oval or ellipse is an example of the isoperimetric inequality in mathematics.

Thus, as explained above, as the oval cross-section of tube 100 tends toward a more circular cross-section, the cross-sectional area increases, resulting in a volumetric increase of the tube. In some implementations, tube 100 may be filled with a liquid that expands in volume when it freezes. In other implementations, tube 100 may be filled with a solid that expands in volume when it liquifies. In either of these implementations, tube 100 itself may accommodate this volumetric increase of the phase-changing liquid or solid by also volumetrically expanding. In contrast, if the tube did not expand, then the internal forces of the volumetrically-expanding phase-changing liquid or solid may fracture the wall of the tube. Such a fracture may be avoided if the wall material of the tube could substantially stretch. As discussed below, however, such materials (e.g., plastics or rubber) may be relatively poor thermal conductors and thus may not be preferred in some applications.

FIG. 3 is a cross-section view of an oval resilient tube 300 having a varying wall thickness, according to some embodiments. For example, tube 300 may be the same as or similar to tube 100, wherein each of these tubes may have a wall thickness that varies over its perimeter. Dashed rectangle 302 represents a top portion of the wall 304 of tube 300 having a thickness that is thinner than that of wall 304 in a side portion of tube 300, represented by dashed rectangle 306. In this implementation, outward forces applied uniformly on wall 304 may tend to reshape the oval outline of tube 300 by increasing the tube's width in the Y-direction. One reason for this reshaping is because the wall's resistance to bending is lower for relatively thin portions of the wall as compared to relatively thick portions of the wall. In terms of strain, the radial strain at portion 302 is greater than the radial strain at portion 306, wherein radial strain at a point on the perimeter is defined as the change in radius per the initial radius at the perimeter (radius being measured from the center of the oval). It is worth noting that wall thickness need not vary and may instead be constant over the entire perimeter. In such implementations, outward forces applied uniformly on a uniformly thick wall may tend to reshape the oval outline of the tube by increasing the tube's width in the Y-direction because the forces in the Y-direction are applied to a larger surface area as compared to the forces in the X-direction.

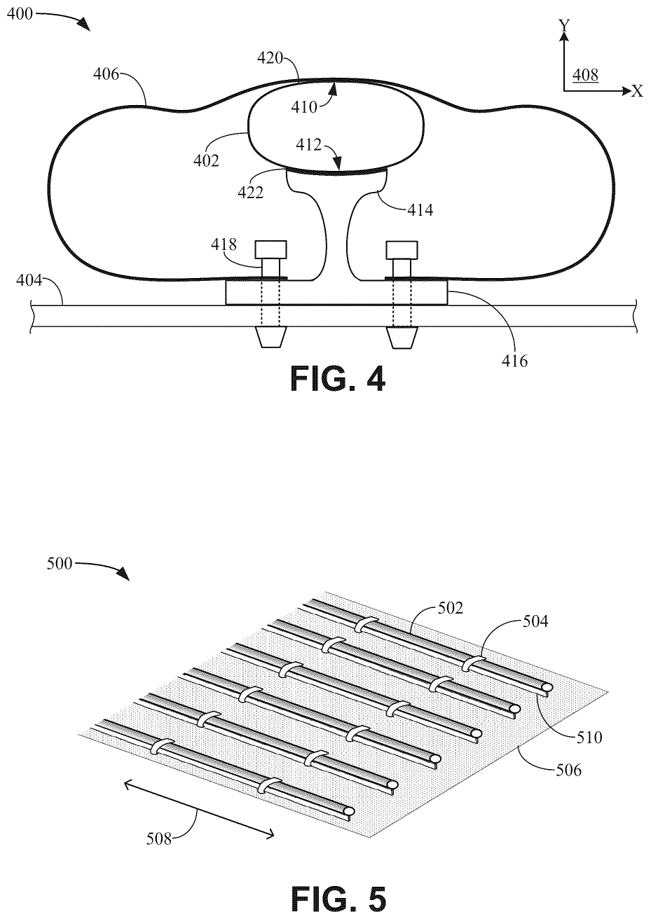

FIG. 4 is a cross-section view of a resilient tube system 400 that includes an oval resilient tube 402 mounted onto a radiator 404 by a clip 406 (e.g., a retainer clip), according to some embodiments. X-Y axes 408 are included in the figure for directional reference. Tube 402, which may be the same as or similar to tube 100 or 300, is widest in the X-direction and narrowest in the Y-direction, which is perpendicular to the X-direction. Accordingly, a top portion 410 and a bottom portion 412 are wider than the side portions. Clip 406 may be configured to apply a downward (e.g., in the negative Y-direction) force on top portion 410 of tube 402. This force may arise from the clip's resilient spring force, which may be based, at least in part, on the prefabricated shape of the clip. For example, clip 406 may be flexed when fitted onto and over tube 402. The flex may be the basis for the spring force applied onto the tube. Clip 406 may be made of a material that has intrinsic spring-like properties (e.g., spring steel alloys). A feature of clip 406 is that clip 406 may be configured to flex and change shape to accommodate a changing shape of tube 402 as the tube expands in the Y-direction and retracts in the X-direction, for example.

Besides characteristics about clip 406 that are described herein, claimed subject matter is not limited to any particular shape. Accordingly, the shape illustrated in the figure is merely an example.

Tube 402 may be supported at bottom portion 412 by a support structure 414 that, in some implementations (and as illustrated), is attached to radiator 404. For example, support structure 414 may include a relatively wide base 416 that rests, and is attached, on radiator 404. In some embodiments, bolts or screws 418 may be used to hold both clip 406 and support structure 414, via its base 416, to radiator 404. In some implementations, the contact between base 416 and radiator 404 is thermally conductive. A feature of support structure 414 is that the support structure may have a top surface that is shaped (e.g., concave) to accommodate a changing shape (e.g., curvature and width) of tube 402 as the tube expands in the Y-direction and retracts in the X-direction, for example.

System 400 may be configured as a thermal radiator wherein tube 402 carries a working (heat carrying) fluid that transfers its heat to (or from, in the case for a cooling system) radiator 404, which may have a relatively large area for dissipating (or absorbing) heat to (or from) the surrounding medium (e.g., via convection and/or radiation). To assist in conducting heat from fluid in tube 402 to radiator 404, the wall of tube 402 may be a metal so as to have a relatively high thermal conductivity. Clip 406 and support structure 414 may also be a metal so as to have relatively high thermal conductivities. Additionally, clip 406 may be relatively wide (e.g., in the direction perpendicular to both X and Y) for improved thermal conductivity. With these relatively high thermal conductivities of both clip 406 and support structure 414 (and relatively wide base 416), heat from a fluid in tube 402 may flow to radiator 404.

In some implementations, a thermally conductive resilient material 420 may be compressed between clip 406 and tube 402. A thermally conductive resilient material 422 may also be compressed between support structure 414 and tube 402. Such a thermally conductive resilient material may increase thermal contact between adjacent surfaces by bridging the gap between the surfaces. The size and shape of such a gap may change with the changing shape (e.g., curvature and width) of tube 402 as the tube expands in the Y-direction and retracts in the X-direction, for example. Material 420 and 422 may be a thermal foam, polymer sheet, or a gel, just to name a few possibilities.

As mentioned above, claimed subject matter (unless so claimed) is not limited to any particular shape or characteristic of a tube's cross-section. Thus, a tube having an elliptical or circular cross-section, or even a rectangular cross-section, may be applied to other embodiments of the resilient tube system 400.

FIG. 5 is a perspective view of a radiator 500 that includes oval resilient tubes 502 mounted thereon, according to some embodiments. Clips 504 may be placed at intervals along the lengths of the tubes. The clips may provide at least two functions. First, the clips may be used to support and secure the tubes to a radiating surface 506 of radiator 500. Second, the clips may be made of a thermally conductive material (e.g. metal) so as to relatively efficiently transfer heat from fluid carried in tubes 502 to surface 506. For at least this reason, clips 504 may be relatively wide in a direction along the length of tubes 502, as indicated by arrow 508. In some embodiments, tubes 502 may be the same as or similar to tubes 100, 300, or 402 and clips 504 may be the same as or similar to clip 406.

A support structure 510, which may be the same as or similar to 414, may be used to support individual tubes 502 and also to attach the tubes to surface 506. In some implementations, bolts or screws (e.g., 418) may be used to hold clips 504 and/or support structure 510 to radiator surface 506. Support structure 510 may be made of a thermally conductive material (e.g., metal) so as to relatively efficiently transfer heat from fluid carried in tubes 502 to surface 506.

FIG. 6 is a perspective view of a radiator 600 that includes oval resilient tubes 602 mounted thereon, according to some embodiments. Clips 604 may be placed at intervals along the lengths of the tubes. Generally, radiator 600 may be the same as or similar to radiator 500 except that tubes 602 may be attached or mounted to a radiating surface 606 of radiator 600 by a different method. For example, instead of using a support structure such as 510, tubes 602 may be placed directly on surface 606. In some implementations, a thermally conductive resilient material 608 may be compressed between surface 606 and tubes 602. A thermally conductive resilient material (e.g., 420) may also be compressed between clips 604 and tubes 602. Such a thermally conductive resilient material may increase thermal contact between adjacent surfaces by bridging the gap between the surfaces. The size and shape of such a gap may change with the changing shape (e.g., curvature and width) of tubes 602, for example. Material 608 may be a thermal foam, polymer sheet, or a gel, just to name a few possibilities.

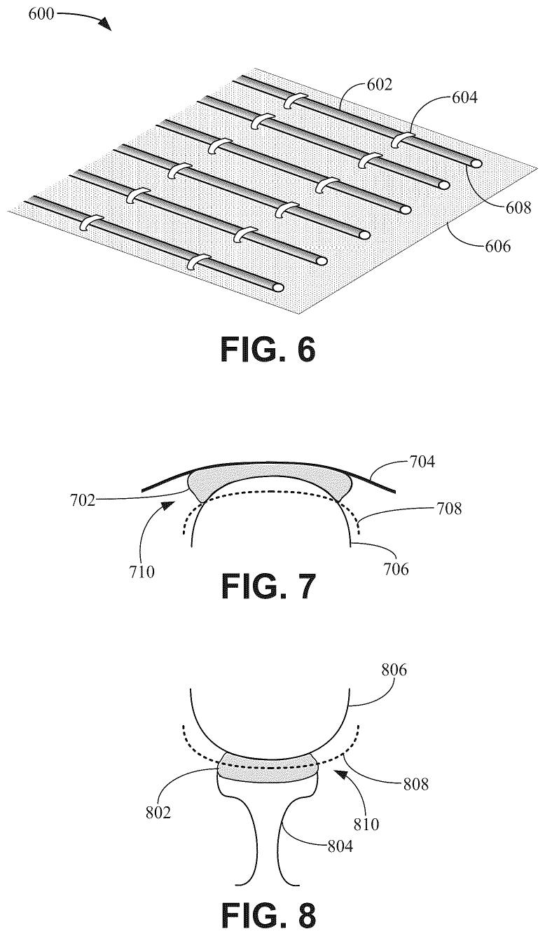

FIG. 7 is a cross-section close-up view of a thermally conductive resilient material 702 between a clip 704 and a shape-changed tube 706, according to some embodiments. A dashed outline illustrates an initial tube shape 708. Material 702 may be the same as or similar to material 420, 422, and 608. Clip 704 may be the same as or similar to clips 100, 300, 406, 504, or 604 and tube 706 may be the same as or similar to tubes 100, 300, 402, 502, or 602, for example.

Material 702, which may be compressed between clip 704 and tube 706, may change shape as a gap 710 between the clip and the tube changes shape. As discussed above these changing shapes may occur with that changing shape (e.g., curvature and width) of the tube as the tube expands in a first direction (e.g., the Y-direction) and retracts in a second direction (e.g., the X-direction), for example.

FIG. 8 is a cross-section close-up view of a thermally conductive resilient material 802 between a support structure 804 and a shape-changed tube 806, according to some embodiments. A dashed outline illustrates an initial tube shape 808. Material 802 may be the same as or similar to material 420, 422, 608, and 702. Clip 704 may be the same as or similar to clips 100, 300, 406, 504, or 604 and tube 706 may be the same as or similar to tubes 100, 300, 402, 502, 602, or 706, for example.

Material 802, which may be compressed between clip 804 and tube 806, may change shape as a gap 810 between the clip and the tube changes shape. As discussed above these changing shapes may occur with that changing shape (e.g., curvature and width) of the tube as the tube expands in a first direction (e.g., the Y-direction) and retracts in a second direction (e.g., the X-direction), for example.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A resilient tube system comprising:
a tube that is configured to carry a fluid, wherein the tube
has an oval cross-section with a top portion, a bottom portion, and side portions, and
is widest in a first direction and narrowest in a second direction that is perpendicular to the first direction, such that the top portion and the bottom portion are wider than the side portions;
a retainer clip applying a net force in the second direction on at least part of the top portion of the tube, wherein the retainer clip is configured to conform with the tube as the tube expands in the second direction.

2. The system of claim 1, wherein the tube is configured to retract in the first direction while expanding in the second direction.

3. The system of claim 2, wherein the retracting and the expanding is in response to a changing phase of the fluid.

4. The system of claim 1, further comprising, between the at least part of the top portion of the tube and the retainer clip, a thermally conductive resilient material.

5. The system of claim 1, further comprising a support structure to support the tube and to counter the net force of the retainer clip.

6. The system of claim 5, further comprising, between at least part of the bottom portion of the tube and the support structure, a thermally conductive resilient material.

7. The system of claim 5, wherein the tube is thermally connected to a radiator by the retainer clip and the support structure.

8. The system of claim 1, wherein the tube is fastened to a radiator by the retainer clip.

9. The system of claim 1, wherein the tube is a metal tube.

10. The system of claim 1, wherein the oval cross-section is expressed by a set of parametric equations X=a(cos(t))(1+fcos2(t)) and Y=b(sin(t))(1+fsin2(t)), wherein t is a parametric variable, a and b are constants that determine a maximum width in the respective first and second directions, and f is a constant in a range between about 0.05 and 0.2.

11. A resilient tube system for carrying a fluid, the system comprising:
oval tubing that is configured to deform from an oval cross-section toward a circular cross-section during a phase change of the fluid between a liquid and a solid;
a retainer clip configured to apply a net downward force on a top of the oval tubing;
and a support structure configured to support a bottom of the oval tubing and to counter the net downward force of the retainer clip.

12. The system of claim 11, wherein the retainer clip is configured to conform with the oval tubing as the oval tubing deforms from the oval cross-section toward the circular cross-section.

13. The system of claim 11, further comprising, between the top of the oval tubing and the retainer clip, a thermally conductive resilient material.

14. The system of claim 11, further comprising, between the bottom of the oval tubing and the support structure, a thermally conductive resilient material.

15. The system of claim 11, wherein the oval tubing is thermally connected to a radiator by the retainer clip and the support structure.

16. A thermal radiator system comprising:
a radiator base;
oval tubing configured to carry a fluid, wherein the oval tubing is configured to deform from an oval cross-section toward a circular cross-section during a phase change of the fluid between a liquid and a solid;
a retainer clip configured to apply a net downward force on a top of the oval tubing; and
a support structure mounted to the radiator base and configured to support a bottom of the oval tubing and to counter the net downward force of the retainer clip.

17. The system of claim 16, wherein the retainer clip is configured to conform with the oval tubing as the oval tubing deforms from the oval cross-section toward the circular cross-section.

18. The system of claim 16, further comprising, between the top of the oval tubing and the retainer clip, a thermally conductive resilient material.

19. The system of claim 16, further comprising, between the bottom of the oval tubing and the support structure, a thermally conductive resilient material.

20. The system of claim 16, wherein a portion of the support structure is sandwiched between distal ends of the retainer clip and the radiator base.
